(19) United States
(12) Patent Application Publication
(10) Pub. No.: US 2002/0133313 A1
(43) Pub. Date: Sep. 19, 2002

(54) Medical image generating apparatus, medical image processing apparatus and medical network system

(75) Inventor: Haruyuki Toda, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Konica Corporation, Tokyo (JP)

(21) Appl. No.: 10/094,719

(22) Filed: Mar. 11, 2002

(30) Foreign Application Priority Data
Mar. 15, 2001 (JP) 073782/2001

(51) Int. Cl. G06F 15/00

(52) U.S. Cl. 702/182; 702/19

(57) ABSTRACT

A medical image generating apparatus for generating medical image data and transmits them to another apparatus. In the medical image generating apparatus, there are provided a preserving means that forms a condition file in which the information for processing the medical image data to output is preset, that administers a plurality of the condition files so as to be grouped as a condition file group, and that preserves a plurality of the condition file groups; a first designating means that designates the condition file group from the plural condition file group; a second designating means that designates the condition file to be used from the designated condition file group; and a means that conducts image processing with the designated condition file.

### BACKGROUND OF THE INVENTION

The present invention relates to a medical image generating apparatus, a medical image processing apparatus and a medical network system.

Radiographic images are commonly used for diagnoses of sickness, and a known method for obtaining the radiographic image is one wherein radiations which are emitted from a radiation emitting section and are transmitted through a subject are absorbed in a plate-shaped stimulable phosphor, then, the stimulable phosphor is scanned by a laser beam to be excited, thereby, radiation energy (radiographic image information) accumulated in the stimulable phosphor through the aforesaid absorption is made to radiate as fluorescence, and the fluorescence is subjected to photoelectric transfer to obtain radiographic image signals and thereby to read the radiographic image.

In the medical image generating apparatus that reads medical images and obtains them in the aforesaid manner has been provided with condition keys which set a radiographing condition, an image processing condition and an outputting condition in advance, and with a plurality of condition files each corresponding to each condition key. The condition file includes information of regions to be radiographed and a radiographing direction to be information of image processing, but only one condition file group is used even when a plurality of image generating sections exist in the image generating apparatus and how each image generating section is used is different. Accordingly, correspondence between the condition file in the condition file group and the image generating section is not clear, which does not make it easy to operate. When an image processing apparatus which is separate from the image generating apparatus is provided, the same processing as that of the image generating apparatus cannot be carried out, because the image processing apparatus does not have the condition file.

### SUMMARY OF THE INVENTION

An object of the invention is to provide a medical image generating apparatus, a medical processing apparatus and a medical network system, wherein operation is easy and selection of the optimum condition file is easy even when a form of using the image generating apparatus is different.

To achieve the object stated above, the medical image generating apparatus of the invention is one that generates medical image data and transmits them to another apparatus wherein a preserving means that forms a condition file in which the information for processing image data to output, and preserves a plurality of the condition file groups by administering a plurality of the condition files to be in the same condition file group, a first designating means that designates the condition file group from the aforesaid plural condition file group, a second designating means that designates the condition file to be used from the aforesaid designated condition file group, and a means that conducts processing with the designated condition file.

In the medical image generating apparatus, it is possible to provide a pattern of a plurality of condition file groups corresponding to forms of using the image generating apparatus and thereby the optimum condition file can be selected easily and operations become easy, because a plurality of condition file groups are preserved, then, a condition file group can be designated from the foregoing, and the condition file can be designated and used.

The medical processing apparatus of the invention is one that receives medical image data from another apparatus wherein a preserving means that forms a condition file in which the information for processing image data to output, and preserves a plurality of the condition file groups by administering a plurality of the condition files to be in the same condition file group, a first designating means that designates the condition file group from the aforesaid plural condition file group, a second designating means that designates the condition file to be used from the aforesaid designated condition file group, and a means that conducts processing with the designated condition file.

In the medical processing apparatus, it is possible to provide a pattern of a plurality of condition file groups corresponding to forms of using the image generating apparatus, because a plurality of condition file groups are preserved, then, a condition file group can be designated from the foregoing, and the condition file can be designated and used. It is also possible to provide a condition file that is the same as that for the image generating apparatus, and the processing can be made to be common also for the image generating apparatus.

The medical processing apparatus of the invention is one that receives medical image data from another apparatus wherein a preserving means that forms a condition file in which the information for processing image data to output, and preserves a plurality of the condition file groups by administering a plurality of the condition files to be in the same condition file group, a means to designate the condition file group in which the information for processing image data to output is set in advance, corresponding to each receiving channel, a means to determine the condition file through the method specified in advance, from the designated condition file group for the received image data, and a means that conducts processing with the determined condition file.

In the medical processing apparatus, it is possible to provide a pattern of a plurality of condition file groups corresponding to forms of using the image generating apparatus, for example, because a condition file group corresponding to each receiving channel can be designated and the condition file can further be determined, and thereby selection of optimum condition file is easy and operation is easy. Incidentally, the receiving channel is an acceptance inlet for communication, and each of apparatuses such as an image generating apparatus and an processing apparatus is allotted to each channel.

The still further medical processing apparatus of the invention is one that receives medical image data from another apparatus wherein a preserving means that forms a condition file in which the information for processing image data to output, and preserves a plurality of the condition file groups by administering a plurality of the condition files to be in the same condition file group, a means to designate the condition file group in which the information for processing image data to output is set in advance, corresponding to each inputting device, a means to determine the condition file through the method specified in advance, from the designated condition file group for the received image data, and a means that conducts processing with the determined condition file.

In the medical processing apparatus, it is possible to provide a pattern of a plurality of condition file groups corresponding to forms of using an inputting device such as the image generating apparatus, for example, to a plurality of image generating apparatuses, because a condition file group corresponding to each inputting device can be designated and the condition file can further be determined, and thereby selection of optimum condition file is easy and operation is easy. Incidentally, the inputting device means a type of an apparatus allotted to the receiving channel.

Further, the medical network system of the invention is a medical network system including a medical image generating apparatus that generates medical image data and transmits them to another apparatus, and a medical processing apparatus that receives the image data through the network, wherein there is provided a preserving means for common use for the medical image generating apparatus and the medical processing apparatus that forms a condition file in which the information for processing image data to output, and preserves a plurality of the condition file groups by administering a plurality of the condition files to be in the same condition file group, the medical image generating apparatus can designate the condition file from the plural condition file groups for the medical processing apparatus, and the designated condition file becomes the condition file of default of processing, when the condition file is designated from the medical image generating apparatus for the medical processing apparatus.

In this network system, the optimum condition file can be selected, and operations become easy, because the condition file is designated out of condition file groups to the processing apparatus from the image generating apparatus.

In this case, the designating means can designate the condition file by collateral information of image data transmitted to the processing apparatus from the image generating apparatus. Or, the designating means can designate the condition file by the command separate from image data transmitted to the processing apparatus from the image generating apparatus, or by the separate file.

Further, the medical network system of the invention is a medical network system including a medical image generating apparatus that generates medical image data and transmits them to another apparatus, and a medical processing apparatus that receives the image data through the network, wherein there is provided a preserving means that forms a condition file in which the information for processing image data to output to be provided respectively on the medical image generating apparatus and the medical processing apparatus, and preserves a plurality of the condition file groups in the same contents essentially by administering a plurality of the condition files to be in the same condition file group, the medical image generating apparatus can designate the condition file from the plural condition file groups for the medical processing apparatus, and the designated condition file becomes the condition file of default of processing, when the condition file is designated from the medical image generating apparatus for the medical processing apparatus.

In this network system, the optimum condition file can be selected, and operations become easy. Incidentally, a means that holds and shares a condition file group may be a storage device such as a shared hard disc of another device connected through an image generating apparatus, an processing apparatus or the network.

In this case, the designating means can designate the condition file by collateral information of image data transmitted to the processing apparatus from the image generating apparatus. Or, the designating means can designate the condition file by the command separate from image data transmitted to the processing apparatus from the image generating apparatus, or by the separate file.

Further, the still another medical network system of the invention is a medical network system including a medical image generating apparatus that generates medical image data and transmits them to another apparatus, and a medical processing apparatus that receives the image data through the network, wherein the medical image generating apparatus has therein a means to change the condition file in which the information for processing image data and for outputting them and a means that transmits the changed condition file to the medical processing apparatus, and the medical processing apparatus changes to the condition file received from the medical image generating apparatus, in the case of at least one of boot up, shut down and inputting designation from an operator.

In this network system, when the condition file is changed at the medical image generating apparatus, the changed condition file is automatically updated at the processing apparatus side, thus, both apparatuses can be provided with the same condition file.

In this case, it is possible to arrange so that the transmitting means may be provided with a means that writes the changed condition file on a common folder provided on the image generating apparatus, the processing apparatus or other apparatuses.

Further, the still another medical network system of the invention is a medical network system including a medical image generating apparatus that generates medical image data and transmits them to another apparatus, and a medical processing apparatus that receives the image data through the network, wherein the medical processing apparatus has therein a means to change the condition file in which the information for processing image data and for outputting them and a means that transmits the changed condition file to the medical image generating apparatus, and the medical image generating apparatus changes to the condition file received from the medical processing apparatus, in the case of at least one of boot up, shut down and inputting designation from an operator.

In this network system, when the condition file is changed at the medical processing apparatus, the changed condition file is automatically updated at the image generating apparatus side, thus, both apparatuses can be provided with the same condition file.

In this case, it is possible to arrange so that the transmitting means may be provided with a means that writes the changed condition file on a common folder provided on the image generating apparatus, the processing apparatus or other apparatuses.

### BRIEF DESCRIPTION OF THE DRAWINGS

FIG. 1 is a diagram showing the structure of a medical network system in the embodiment of the invention.

FIG. 2 is a block diagram showing the structure of medical image generating apparatus 1 shown in FIG. 1.

FIG. 3 is a block diagram showing the structure of medical image generating apparatus 2 shown in FIG. 1.

FIG. 4 is a block diagram of a controller of medical image generating apparatus 1 shown in FIG. 2.

FIG. 5 is a flow chart showing an example wherein the condition file is designated and is transmitted together with an image file by an image generating apparatus in FIG. 1.

FIG. 6 is a flow chart showing an example wherein the image processing apparatus shown in FIG. 1 conducts image processing and transmission under the condition of the condition file received from the image generating apparatus.

FIG. 7 is a flow chart wherein the condition file has been updated on the image generating apparatus shown in FIG. 1.

FIG. 8 is a flow chart showing an example of the flow up to the moment when the condition file has been updated on the image processing apparatus by the updating of the condition file on the image generating apparatus shown in FIG. 7.

### DETAILED DESCRIPTION OF THE INVENTION

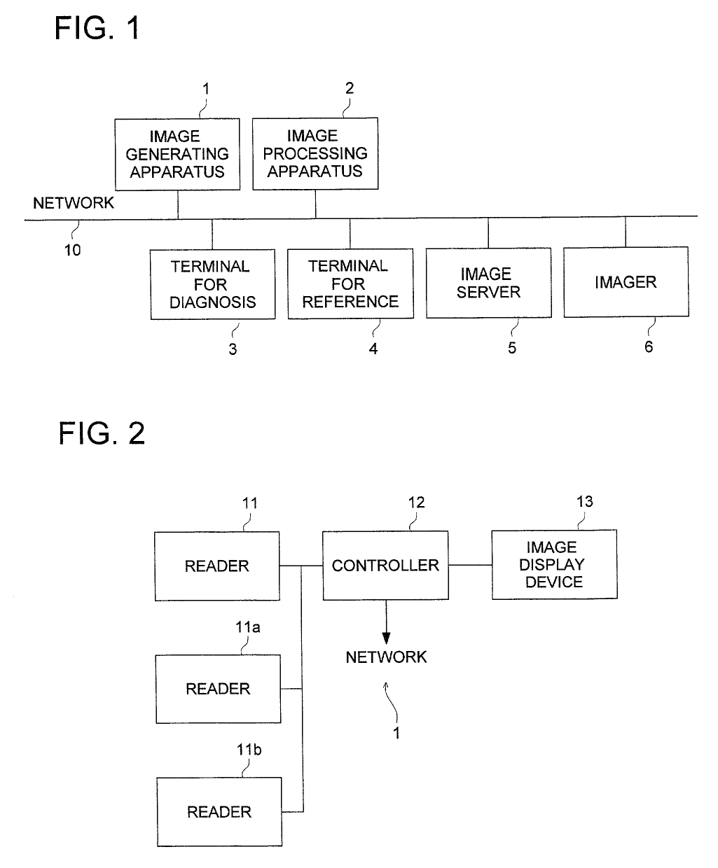

The medical network system in the embodiment of the invention will be explained as follows, referring to the drawings. FIG. 1 is a diagram showing the structure of a medical network system in the embodiment of the invention.

The medical network system shown in FIG. 1 is provided with medical image generating apparatus 1 wherein a medical image is generated by a radiographing modality of CR (computed radiography) that scans a stimulable phosphor panel in which radiographic image information of a subject (patient) is recorded to make it to emit light and transfers the light photoelectrically to obtain image information, medical image processing apparatus 2 that inputs an image file from the medical image generating apparatus 1 and outputs image information after conducting image processing, and with terminal for diagnosis 3 that is composed of a personal computer and a work station, and is used by a radiologist to diagnose by referring to images.

The medical network system shown in FIG. 1 is further provided with terminal for reference 4 that is composed of a personal computer and a workstation displaying images, and is inferior in quality such as resolution compared with the terminal for diagnosis 3 because no diagnosis is made although images are referred to, image server 5 that is composed of a personal computer and a workstation, and can store an image file in image data base and can detect images from the terminal for diagnosis 3 and from the terminal for reference 4 to read them, and imager (printer) 6 that outputs image data from medical image generating apparatus 1 and medical image processing apparatus 2 on a recording medium such as a film or paper. Each of the items 1-6 stated above is connected on an on-line connection basis through the network 10, so that information may be transmitted and received mutually.

Apparatuses 1-6 are connected on an on-line basis through the network 10 so that they can transmit and receive information each other. Further, in the present system, an image generating apparatus and an image processing apparatus are allotted for each receiving channel. Incidentally, the receiving channel is an acceptance inlet for communication and it is stipulated by an IP address or a port number. An inputting device representing an apparatus allotted to a receiving channel includes a standing position and a lying position of CR representing a type of an image generating apparatus, a cassette type, and apparatuses such as DR and CT. When receiving from an image processing apparatus, a type of the image processing apparatus will do.

Next, the following items A-I relating to medical image generating apparatus 1 in FIG. 1 will be explained in detail successfully.

A. Apparatus structure

B. Information

C. File

D. Input and display of main information

E. Reserving procedures

F. Radiographing procedures

G. Transfer

H. Output image forming

I. Utility function

A. Apparatus Structure

FIG. 2 is a block diagram showing the structure of medical image generating apparatus 1, and FIG. 4 is a block diagram showing the structure of a controller shown in FIG. 2.

a. As shown in FIG. 2, the medical image generating apparatus 1 is provided with radiographic image inputting apparatus (reader) 11 that converts information read from a stimulable phosphor panel on which radiographic image information of an object (patient) is accumulated, recorded and stored in a cassette, to obtain, a main control apparatus (controller 12) that controls operations of the whole radiographing system for radiographic images, and image display device 13 that is composed of a CRT display or of a liquid crystal panel and displays digital image data obtained by the reader 11. Incidentally, the medical image generating apparatus 1 may also be provided with reader 11a, and it can include a plurality of readers. It further includes information inputting devices such as an input key board and a mouse.

The medical image generating apparatus 1 is further provided with reader 11a which obtains by converting, into digital image data, the information obtained through reading from a stimulable phosphor panel in a radiographing apparatus of a standing type that radiographs a standing patient, and reader 11b which obtains by converting, into digital image data, the information obtained through reading from a stimulable phosphor panel in a radiographing apparatus of a lying type that radiographs a lying patient.

b. The controller 12 constitutes a man-machine interface which is operated by a user (radiologist), and controls the whole of the medical image generating apparatus 1. As shown in FIG. 4, the controller 12 includes reading control section 36 that receives image data from readers 11 and 11a and conducts correction processing on a real time basis, preserving section 31 that is composed of a hard disc or RAM and stores and preserves various types of information such as image files from the reading control section 36, image processing section 32 that conducts image processing for image information in the image files, output image forming section 33 that forms output images to be outputted to the outside, image confirming/processing section 35 that conducts image processing for image confirmation and makes display device 13 to display reduction images, and main control apparatus 34 that controls operations of the whole apparatus including various sections 31-33 and 35 and the display device.

c. The controller 12 conducts the following operations (1)-(7) to be concrete.

1) A user operates for an appointment of radiographing.

2) A user operates for radiographing.

3) To receive image data obtained through reading by readers 11 and 11a.

4) To preserve image data in preserving section 31 temporarily.

5) To conduct image processing at image processing section 32.

6) To form output images at output image forming section 33.

7) To transmit to an outer apparatus such as image server 5 through the network 10.

B. Information

Information handled by the medical image generating apparatus 1 can be classified into the following five types of information.

a. Radiographing Information

Information with which radiographing is conducted to obtain image data which are outputted to an outer apparatus such as image server 5 as an image file.

The radiographing information includes the following information.

(a) Reader Reading Condition

Information concerning a method for reading by readers 11 and 11a, namely, an area to be read, a pixel size for reading and sensitivity for reading.

(b) X-ray Apparatus Information

Control information in the case of an occasion where a radiographing apparatus is connected to the network 10 on an on-line basis and is controlled from the system shown in FIG. 1, namely, X-ray tube voltage, X-ray tube current, X-ray radiation time and an area for radiation.

(c) Image Processing Information

Information relating to gradation processing and frequency processing in image processing of image data at image processing section 32.

(d) Outputting Apparatus Information

It is information relating to outer outputting apparatuses such as terminal for diagnosis 3, terminal for reference 4, image server 5 and imager 6 in FIG. 1 which reproduce image data for outputting them, and various pieces of information such as an area to be outputted, magnification and rate of reduction, output format (multi-format, split radiographing format), overlay and existence of gradation processing and frequency processing are designated for each outputting apparatus.

(e) Overlay Information

Information about existence and position of overlay such as AP/PA, R/L and comment.

(f) Information about Specific Designation

Information of protection: Image file is preserved in preserving section 31 until a protection is removed, even after image transmission.

Information of pending: Transmission is reserved. This is designated when transmission is needed after the image is reviewed.

Information of priority (emergency): This is designated when preferential transmission such as emergency radiographing is required. This is registered to be at the forefront of a cue.

b. Patient Information

Information concerning patients including the following information.

(a) Patient ID Information

An ID number, a full name, the distinction of sex and the date of birth of a patient.

(b) Order Information

Information with which a doctor requests radiographing, which includes information relating to patient conditions and instructions for the date and method for the inspection requested.

c. Information of Radiographing Implementation

Information concerning the results of radiographing which includes the following information.

(a) Results of Radiographing

Date and number for radiographing.

(b) Results of Image Processing

This is a result of calculation of image processing parameter, and image data are processed at image processing section 32 based on this result when outputting.

(c) System Information

This includes a part of system information such as a system structure at the point of time when radiographing is conducted.

d. System Information

This is information for controlling the whole system in FIG. 1, and it includes established information relating to outputting apparatuses such as system structures (outer apparatus such as image server 5 connected and it name), parameter to control equipment constituting the system, a table, reader information, imager information and HOST information.

e. Image Data

The following image data are included.

(a) Image data inputted from readers 11 and 11a.

(b) Reduction image data for display for making image display device 13 to display for image confirmation.

(c) Reduction image data for image processing for image processing of reduction image for display at image confirming/processing section 35.

(d) Output image data such as gradation processing and frequency processing.

C. File

A file handled by medical image generating apparatus 1 is preserved in preserving section 31, and it is classified into the following seven files.

a. Condition File

A radiographing condition key is a key for setting in advance radiographing conditions, image processing conditions and outing conditions, and it has a condition file that corresponds to each radiographing condition key. The condition file is composed of the radiographing information above mentioned. It is classified in terms of radiographing regions (lung, abdomen, head and others), radiographing posture (standing posture, lying posture and others), radiographing direction (front, side and others), characteristics of a patient (the distinction of sex, age, physical structure and others), the name of a disease and a radiologist, and a name and radiographing information corresponding to each of them are established in advance. Controller 12 establishes a condition file group for each of classified plural classifications, then, sets plural condition files for each condition file group thus established, and preserves in preserving section 31. The optimum condition is selected in the course of generating images.

b. Reservation File

This is a file in which information relating to radiographing reservation is preserved. One reservation file is prepared for each radiographing. The reservation file is composed of radiographing information selected by a radiographing condition key and of patient information.

c. Image Header File

After completion of radiographing, an image header file is prepared. The header file is composed of a reservation file of the radiographing (namely, radiographing information, patient information) and information of conducting radiographing. When a user refers to radiographing information, patient information and information of conducting radiographing for changing, the user refers to an image header file.

d. Reduction Image File

This represents image data which are obtained by reducing image data by image confirming/processing section 35 at a certain reduction ratio for image confirmation, and it includes the following. Incidentally, a method of image reduction includes a simple thinning out method, an averaging method and a spline method.

(a) Reduction Image Data for Display

This reduction image for display is used by image data displayed on image display section 13 in FIG. 2 and FIG. 4.

(b) Reduction Image Data for Image Processing

This represents reduction image data for calculating a parameter with which the image confirming/processing section 35 conducts image processing. The reduction rate is determined so that a length of one pixel after reduction may be the same as a length designated in advance. Due to this, it is possible to correct the difference in a size of a pixel to be read with the image after being reduced. Calculation of a parameter for image processing is conducted by the reduction image for image processing, and image data are not used.

e. Image Data File

Corrected image data received from readers 11 and 11a in FIG. 2 are preserved in preserving section 31.

f. Output Image Data File

This is a file of output image data which have been subjected to the designated processing among frequency processing, gradation processing, overlay, rotation and enlargement and reduction.

g. System File

This is one wherein the system information mentioned abovel is filed.

D. Inputting and Display of Main Information

a. Reading Area

1) The reading area is an area where radiographic images accumulated in a stimulable phosphor are converted into image data. An appropriate area is designated in accordance with a region to be radiographed.

2) A size for reading, a direction and a position are designated, and registered in a condition file in advance.

3) When a condition file is selected, the reading area is displayed on a screen of image display device 13 in FIG. 2 under the condition designated in advance. A size of a display area of the reading area on the screen of the image display device 13 is made to be the maximum reading area in reading (normally, a 345×430 mm size). The reading area is determined from the designated reading size, the direction and the position, and is displayed graphically on the reading area display area. Due to this, appropriate reading size, direction and position can be selected and confirmed.

4) An irradiated area is received from an X-ray apparatus, and is displayed simultaneously on the reading area display area.

b. Output Area

1) The output area is an area for outputting to an outer apparatus such as image server 5.

2) An outputting size, a direction, a trimming position, an outputting position and a method of enlargement and reduction are designated, and registered in a condition file in advance.

3) When a radiographing condition key is selected, the output area and output image area are determined under the condition designated in advance, and are displayed on the screen of the image display device 13. A size of the output area display area on the screen of the image display device 13 is made to be the maximum output area in outputting. An output area and an output image area are displayed graphically on the output area display area. Due to this, the appropriate output area and the output image area can be selected and confirmed.

c. Overlay Information

1) It is designated whether or not “AP”, “PA”, “R”, “L”, comment and a division are overlaid, or where they are overlaid, and they are registered in a condition file in advance.

2) Output images are displayed on an output area display area on the screen of the image display device 13, and overlay information is displayed graphically there.

3) If a portion on the output area display area which needs to be overlaid is touched, overlay graphics are moved to that portion.

4) It is possible to select an appropriate overlay and to designate a position.

5) It is possible to confirm that a portion screened by the overlay to be invisible is not present. When the overlay causes troubles on diagnoses, it can be moved.

d. Inputting and outputting of on-line information from RIS

1) Orders from a doctor are inputted. The orders thus inputted are converted into the format of this system to be preserved in the reservation file. The radiographing region and radiographing method are converted into corresponding radiographing conditions.

2) An image header file is converted into the format on the RIS side, and outputted.

e. Reservation List

1) Reservations for radiographing can be displayed on the screen of the image display device 13 as a list in the order of reservations.

2) After completion of radiographing, the reservation for radiographing registered to be in the forefront of the reservation list is automatically set by controller 12 to be ready for radiographing.

3) The reservation for which radiographing has been finished is not erased, and is preserved until the number of the finished reservations arrives at the designated value. Due to this, retaking under the same condition and for the same patient such as retaking after confirmation of hard copy can be conducted easily.

E. Reservation Procedures

There are three inputting methods depending on environment of facilities where the system shown in FIG. 1 is installed.

a. On-line

1) Information necessary for radiographing such as patient information and radiographing information are mostly inputted from RIS in image generating apparatus 1 through the network 10 on an on-line basis.

2) A key board is not needed usually. When information that is not included in information from RIS needs to be inputted, an information inputting apparatus such as a key board is used.

3) Patient information is reserved through a multi-task basis even when radiographing, by inputting orders from a doctor on an on-line basis. Usually, setting is made for each facility so that all pieces of information relating to the patient may be taken in.

4) With regard to radiographing information, orders from a doctor are inputted together with patient information on an on-line basis, and the doctor selects the optimum radiographing method from radiographing key in the case of an order. Or, controller 12 automatically selects the radiographing condition key which is most suitable for the order designated by the doctor.

b. Magnetic Card, Bar Code and Others

1) Only necessary and minimum information such as an ID number or a patient name is inputted on an on-line basis

2) When information that is not included in a card needs to be inputted, it is inputted from the key board.

3) With regard to patient information, necessary and minimum information relating to radiographing is read from a magnetic card. In case of need, collateral information is inputted from a key board.

4) With regard to radiographing information, a radiographing condition key used for preceding radiographing is selected automatically by controller 12. When a change is needed, selection is made from the inside of the radiographing condition key.

c. Key Board Input

1) Necessary information is totally subjected to key board inputting.

2) Patient information is inputted from a key board. Since it is time-consuming to input all of patient ID numbers and patient names manually, it is possible to use a mode to prepare a patient ID number automatically from the number of sheets radiographed (number of sheets which have been radiographed) and radiographing time, to correspond to the order written on a sheet of paper.

3) Radiographing information is selected from a radiographing condition key.

F. Radiographing Procedures

a. The following represents procedures which are followed by a user for radiographing.

1) When the preceding radiographing is completed, or when the sequence enters a radiographing mode, a screen for the following radiographing appears, and radiographing information for radiographing reserved to be at the forefront is displayed on a screen of image display device 13.

2) When there is no reservation, the reservation needs to be made by selecting a radiographing condition key here. A default is a radiographing condition key used in the preceding radiographing. When information for radiographing is insufficient, necessary information needs to be inputted here.

3) A user observes patient information and radiographing information displayed on a screen of the image display device 13 in FIGS. 2 and 4, and confirms whether the setting is correct or not.

4) A user (radiologist) radiographs in the same way as in radiographing by means of a film.

5) Images obtained through radiographing are displayed on a screen of the image display device 13 in succession simultaneously with image reading.

6) Gradation processing is conducted to be displayed again.

7) Success or failure for radiographing and success or failure for processing are displayed on a message basis.

8) A user confirms from images and messages that radiographing has been conducted correctly, and pushes a key for completion of radiographing.

9) When radiographing fails, a user pushes a key for retaking.

b. System Operations in Radiographing

(1) Radiographing mode is started (a radiographing mode key is pressed). When detecting that a radiographing mode key is pressed, the controller 12 makes a control mode to move to a radiographing mode.

(2) When a reservation is made in advance (a reservation file is present), the contents of reservation registered to be at the forefront of a cue for controlling a reservation file are displayed on a screen of the image display device 13.

(3) When there is no reservation, a radiographing condition key used for preceding radiographing is selected automatically by controller 12. If reservation is needed, re-selection and correction of the radiographing condition key and inputting of patient information are conducted.

(4) Radiographing is started by pressing a radiographing switch of a radiation emitting device.

(5) X-rays are irradiated on a subject from the radiation emitting device, and radiographic images accumulated in a stimulable phosphor panel are read by readers 11 and 11a through scanning by excitation light.

(6) Reading control section 36 receives image data from the reader, and stores them in a memory for images while conducting correction processing on a real time basis.

(7) The image data stored in a frame memory are reduced, at image confirming/processing section 35, at the reduction rate designated in advance.

(8) Reduction images obtained through processing in the image confirming/processing section 35 in succession are displayed on a screen of the image display device 13.

(9) After completion of reading and display, digital image information is subjected to image processing in a method designated by a radiographing key in advance, and is displayed again. Reduction images are utilized for image processing.

(10) At the same time, the digital image information is stored in preserving section 31 temporarily.

(11) Images displayed in succession on the image display device 13 and subjected to gradation processing after displaying are displayed again.

(12) After reading is completed, a reservation file and information of conducting radiographing are preserved in preserving section 31 as an image header file.

(13) Reduction image data are preserved in preserving section 31 as a reduction image file.

(14) An image header file and a reduction image data file are controlled together with image data to be corresponded with a common specific number.

(15) Preservation of these files in preserving section 31 is conducted automatically by main control apparatus 34 of the controller 12, after completion of reading by readers 11, 11a and 11b and before confirmation operations of an operator. The reason for this is to prevent that images obtained through radiographing may not be lost even when the power supply is turned off immediately after completion of reading by the accident or by erroneous operations of an operator, even when troubles are caused on the system.

(16) After completion of reading, operations of an operator turn out to be possible.

(17) When an operator judges the radiographing to be normal by observing radiographic images displayed on the image display device 13, a key (key for succeeding radiographing key) for confirming completion of radiographing is inputted from a character information inputting device, and radiographing is completed.

(18) When patient information, an image processing method and an outputting method are required to be changed, it is possible to input new information from the character information inputting device.

(19) When the succeeding radiographing key is pressed, radiographing corresponding to that key is completed, and the following reservation is displayed automatically on the image display device 13.

(20) When the radiographing is judged to have failed, it is possible to cancel the image and to retake by pressing a retaking key.

(21) When the succeeding radiographing key is pressed, radiographing corresponding to that key is completed, and the following processing is conducted.

(22) The reservation file is preserved in preserving section 31 as a radiographed reservation file.

1) When there is a change of information before the succeeding radiographing key is pressed, an image header file preserved at the moment when reading is completed is updated.

2) An image for which radiographing has been finished is registered in a cue for transmission to an outer apparatus.

3) The reservation file reserved next is read and displayed to be capable of being radiographed.

(23) When a retaking key is pressed, radiographing is completed, and the following processing is conducted.

1) Image header file and reduction image file and image data which are preserved at the point of completion of reading are destroyed.

2) Radiographing in the same reservation turns out to be possible.

G. Transmission

(1) Transmission is conducted on a non-synchronization basis.

(2) A cue is made and controlled for each outer apparatus, and each cue operates independently each other, and does not influence each other. Therefore, transmission is conducted for each apparatus on a non-synchronization basis.

(3) Numbers each being given to each image are preserved in a cue in the order of transmission.

(4) The whereabouts of the image in terms of registration in a cue of an outer apparatus is preserved in preserving section 31 as a cue registration table, and it is updated and controlled for each registration and cancellation.

(5) An image registered in the cue is transmitted to an outer apparatus of image server 5 in the order of registration, and the image whose transmission is finished is canceled from the cue.

(6) When carrying out transmission, an image header file and an image data file both stored in preserving section 31 are specified from numbers registered in the cue.

(7) An output image is formed under the condition preserved in the image header file. The image header file is converted into the format determined for each outputting apparatus, and is transmitted together with image data file.

H. Forming Output Image

a. An output image is formed by output image generating section 33 mainly through the following processing.

1) Image data are read from preserving section 31 to a memory for images.

2) Frequency processing is conducted.

3) Equalization processing is conducted.

4) Gradation processing is conducted.

5) Rotation of an image is carried out.

6) Mirror reversing is conducted.

7) Enlargement and reduction are carried out.

8) Overlay is carried out.

b. With respect to each of 2)-8), whether it is executed or not can be designated by radiographing information for each outputting apparatus such as image server 5.

c. It is possible to designate that image data subjected to designated processing of each of 2)-8) are preserved as processed image data file. Re-processing of common processing section of output image for each output apparatus is removed.

d. For example, when an enlargement rate and a reduction rate of an output image for each output apparatus are different from others, if images which have been subjected to processing up to 6) are preserved, it is possible to shorten a period of time for 2)-6) by reading images which have been subjected to processing up to 6) and by processing and transferring only 7) and 8), when transmitting to another apparatus.

e. Processing 5) and 6) are conducted simultaneously with either one of 2), 3) and 4). Access of memory is reduced, and processing time can be shortened.

I. Utility Function

As a utility for a user, some functions are provided thereto.

a. Utility function is restricted by a password for each of general user, a manager and a maker. In particular, for a change of information relating to images, a password of a manager is required for security.

b. Image File Operation

1) An image file list is displayed, and information concerning images preserved in preserving section 31 is displayed on image display device 13 in the order of radiographing.

2) When a desired image is selected from the list, patient information, radiographing information and thinned out images are displayed in the same form as in the screen in the case of radiographing.

3) Patient information, image processing methods and outputting methods can be changed.

4) With regard to the image designated to be “reservation” in the case of radiographing, the “reservation” can be canceled by reconfirming here.

5) The image file list can be rewritten in the order of outputting to each outer apparatus.

6) The order of outputting can be changed, including whether outputting to each outer apparatus is conducted or not.

c. Radiographing record, emission record

1) Radiographing information and patient information are processed statistically, and are provided to a user as a radiographing record and an emission record.

2) The number of shots per each radiographing region for a designated period and a list of radiographing conditions for shots per day can be outputted.

Next, the following items A-H relating to medical image processing apparatus 2 shown in FIG. 1 will be explained in detail.

A. Apparatus structure

B. Information

C. File

D. Input and display of main information

E. Image confirming procedures

F. Output

G. Formation of output image

H. Utility function

A. Apparatus Structure

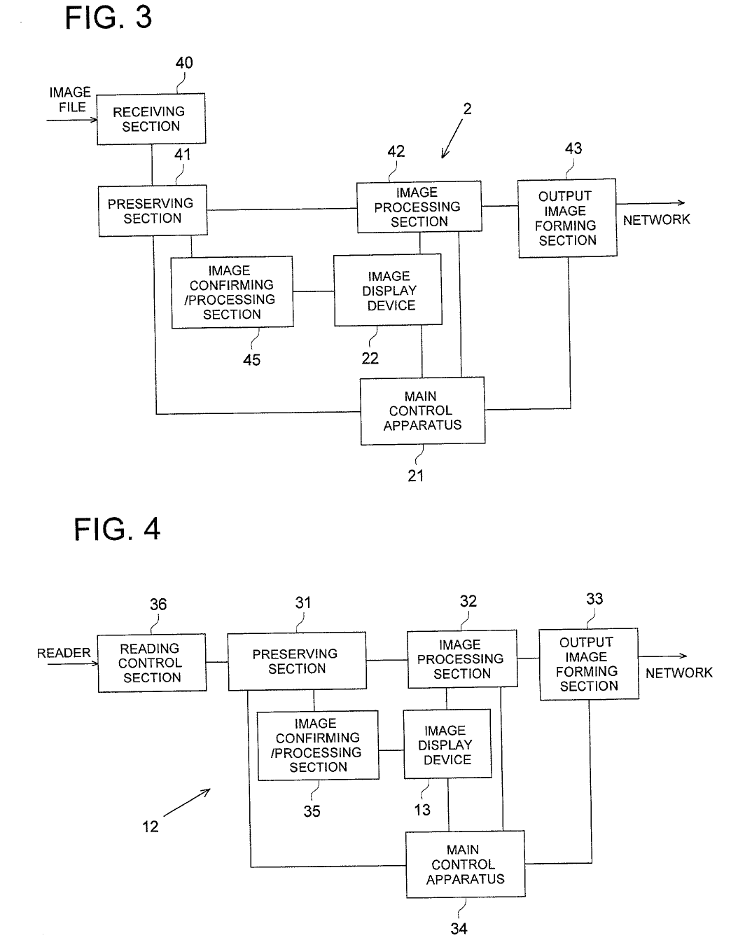

FIG. 3 is a block diagram showing the structure of medical image processing apparatus 2.

a. The medical image processing apparatus 2 shown in FIG. 3 is provided with main control apparatus 21 that controls operations of the whole radiographing system for radiographic images and with image display device 22 for displaying digital image data which are composed of a CRT display and a liquid crystal panel and obtained by medical image generating apparatus 1, and it can be constituted with a personal computer, and includes an information inputting device such as an input key board and a mouse.

As shown in FIG. 3, the image processing apparatus 2 further includes receiving section 40 that receives an image file from image generating apparatus 1 or the like, preserving section 41 that stores information such as an image file that is composed of a hard disc and RAM and received, image processing section 42 that conducts image processing for image information in the image file, output image forming section 43 that forms an output image to be outputted to an outer apparatus, and image confirming/processing section 45 that makes image display device 22 to display reduction images for confirming received images. The sections 40-43 and 44 as well as the image display device 22 are controlled by the main control apparatus 21.

b. Functions of the medical image processing apparatus 2 are as follows, and each function is controlled by the main control apparatus 21.

1) An image file is received by the receiving section 40 from medical image generating apparatus 1.

2) The image file is preserved temporarily in preserving section 41.

3) Image quality is confirmed by reduction images prepared by image confirming/processing section 45.

4) Image processing is carried out on image processing section 42.

5) An output image is formed by output image forming section 43.

6) An output image is transmitted to an outer apparatus such as image server 5 through the network 10.

B. Information

Information handled by the medical image processing apparatus 2 can be classified into the following five types of information.

a. Conditional Information

This is conditional information with which an image file is received and is outputted to an outer apparatus such as image server 5 as a processed image file, and it includes the following.

(a) Image Processing Information

Information relating to gradation processing and frequency processing in image processing section 42.

(b) Output apparatus information

This is information about an outer apparatus such as image server 5 that reproduces and outputs image data, and an output area, magnification and reduction rate, output format (multi-format, split radiographing format), overlay and existence of gradation processing and frequency processing are designated for each outputting apparatus such as image server 5.

(c) Overlay Information

This includes information of existence and position of overlay such as AP/PA, R/L and comment.

(d) Specific Designation

Protection information: Even after image output, an image file is preserved until protection is canceled. Reservation (pending) information: Transmission is reserved. Designation is made when transmission is needed after reviewing an image.

Priority (emergency) information: This is designated when outputting is needed preferentially, such as the case of emergency radiographing.

b. Patient Information

This is information relating to a patient.

(a) Patient ID Information

It includes an ID number, a full name, the distinction of sex and the date of birth all of a patient.

(b) Order Information

This is information with which a doctor requests radiographing.

This includes information about the conditions of a patient and instructions for the date and method relating to the request of inspection.

c. Information of Implementation

This is information relating to the results of receiving and image processing.

(a) The results of receiving and the date and hour of radiographing are included.

(b) Image Processing Result

This is a result of calculation of an image processing parameter, and image data are subjected to image processing based on this result in the case of outputting.

(c) System Information

This includes a part of system information such as a system structure at a point of time when radiographing is conducted.

d. System Information

(a) Information for managing and controlling the system shown in FIG. 1.

(b) Structure the system shown in FIG. 1 (an outer apparatus such as connected image server 5 and its name),

(c) A parameter and a table for controlling apparatuses constituting the system shown in FIG. 1.

(d) Setting information relating to medical image generating apparatus 1 representing an inputting apparatus.

(e) Setting information relating to an outputting apparatus such as information of imager 6 and HOST information

e. Image Data

(a) Image data received from medical image generating apparatus 1.

(b) Reduction image data for display prepared from image data for image confirmation.

(c) Reduction image data for image processing for processing reduction image for display at image confirming/processing section 45.

(d) Output image data subjected to gradation processing and frequency processing.

C. File

A file handled by medical image processing apparatus 2 is preserved in preserving section 41, and it can be classified into the following files in seven types.

a. Condition File

A condition key is a key wherein image processing conditions for image file and output conditions are set in advance, and it has a condition file that corresponds to each condition key. The condition file is composed of the condition information mentioned above. It is classified in terms of radiographing regions (lung, abdomen, head and others), radiographing posture (standing posture, lying posture and others), radiographing direction (front, side and others), characteristics of a patient (the distinction of sex, age, physical structure and others), the name of a disease and a radiologist, and a name and radiographing information corresponding to each of them are established in advance. Main control apparatus 21 establishes a condition file group for each of classified plural classifications, then, sets plural condition files for each condition file group thus established, and preserves in preserving section 41. The optimum condition is selected in the course of generating images.

b. Image Header File

After receiving, an image header file is prepared. The header file is composed of a reservation file of the radiographing (namely, radiographing information, patient information) and information of conducting radiographing. When a user refers to radiographing information, patient information and information of conducting radiographing for changing, the user refers to an image header file.

c. Reduction Image File

This represents image data which are obtained by reducing image data at a certain reduction ratio.

(a) Reduction Image Data for Display

This reduction image for display is used by data displayed on image display section 22 in FIG. 3.

(b) Reduction Image Data for Image Processing

This represents reduction image data for calculating a parameter which conducts image processing. The reduction rate is determined so that a length of one pixel after reduction may be the same as a length designated in advance. Due to this, it is possible to correct the difference in a size of a pixel to be read with the image after being reduced. Calculation of a parameter for image processing is conducted by the reduction image for image processing, and image data are not used.

d. Image File

(a) The image file is composed of image collateral information (image header) and image data.

(b) The image header is composed of condition information, patient information and information of implementation.

When a user refers to condition information, patient information and information of implementation to change, the image header is consulted.

e. Output Image File

This is a file of output image data which have been subjected to designated processing among frequency processing, gradation processing, overlay, rotation and enlargement and reduction.

f. System File

This is one wherein the pieces of information mentioned above are filed.

D. Input and Display of Main Information

a. Received Image Information Display

Received images are displayed on a thumb-nail basis.

b. Output Information Display

1) An output size, a direction, a trimming position, an output position and enlargement reduction methods are designated. These are registered in a condition file in advance.

2) When a condition key is selected, an output area and an output image area are determined by the condition designated in advance, and are displayed on a screen of image display device 22. A size of the output zone display area on the screen of the image display device 22 is assumed to be the maximum output area. The output area and an output image area are displayed graphically on the output zone display area. Due to this, it is possible to select and confirm an appropriate output area and output image area for each apparatus.

c. Overlay Information

1) It is designated whether or not “AP”, “PA”, “R”, “L”, comment and a division are overlaid, or where they are overlaid, and they are registered in a condition file in advance.

2) Output images are displayed on an output zone display area on the screen of the image display device 22, and overlay information is displayed graphically there.

3) It is possible to select an appropriate overlay and to designate its position.

4) It is possible to confirm that a portion screened by the overlay to be invisible is not present. When the overlay causes troubles on diagnoses, it can be moved.

d. Inputting and Outputting of On-line Information from RIS

1) Orders from a doctor are inputted. The orders thus inputted are converted into the format of this system to be preserved in the reservation file. The radiographing region and radiographing method are converted into corresponding radiographing conditions.

2) An image header file is converted into the format on the RIS side, and outputted.

e. Image List

An image file can be displayed as a list.

E. Image Confirming Procedures

a. Operations of System in Image Confirmation

(1) An image file is received from medical image generating apparatus 1, and is stored in preserving section 41.

(2) The image file stored in a storage medium of the preserving section 41 is reduced at the reduction rate * designated by image confirming/processing section 45 in advance.

(3) Reduction images are displayed successively on the screen of image display device 22.

(4) After receiving and completion of display, digital image information is subjected to image processing in the method designated in advance by a radiographing condition key, and is displayed again on image display device 22. Reduction images are used to determine a parameter for image processing.

(5) Images which are displayed successively on the image display device 22 and are subjected to gradation processing after being displayed are displayed again.

(6) When an operator observes received images displayed on the image display device 22 and judges that they are normal images, a key for confirming the completion of receiving is inputted from a character information inputting apparatus, thus, image confirmation is completed.

(7) When patient information, image processing methods and output methods need to be changed, it is possible to input new information from a character information inputting apparatus.

(8) When an image confirming key is pressed, image confirmation for that image is completed, and the following image is displayed automatically.

(9) When an image has a problem, it is possible to change image processing. By reserving it, it is possible to change image processing in detail later.

(10) When an image confirming key is inputted, image confirmation is completed, and the following processing is conducted.

1) The image file is preserved in preserving section 41 as a confirmed image file.

2) Images whose image confirmation has been finished are registered in a cue for outputting to an outer apparatus.

3) Then, the received image file is displayed so that images may be confirmed.

(11) When a reservation key is inputted, image confirmation is completed.

F. Output

1) Output is conducted on a non-synchronization basis with image confirmation.

2) A cue is made and controlled for each outer apparatus, and each cue operates independently each other, and does not influence each other. Therefore, outputting is conducted for each apparatus on a non-synchronization basis.

3) The whereabouts of the image in terms of registration in a cue of an outer apparatus is preserved in preserving section 31 as a cue registration table, and it is updated and controlled for each registration and cancellation.

4) An image registered in the cue is outputted to an outer apparatus in the order of registration, and the image whose outputting is finished is deleted from the cue.

5) When carrying out outputting, an image file stored in preserving section 31 is specified from numbers registered in the cue.

6) An output image is formed under the condition preserved in the image file. The image header is converted into the format determined for each outputting apparatus, and is transmitted together with image data.

G. Forming Output Image

a. An output image is formed by output image forming section 43 mainly through the following processing.

1) Image data are read from preserving section 31 to a memory for images.

2) Frequency processing is conducted.

3) Equalization processing is conducted.

4) Gradation processing is conducted.

5) Rotation of an image is carried out.

6) Mirror reversing is conducted.

7) Enlargement and reduction are carried out.

8) Overlay is carried out.

b. With respect to each of 2)-8), whether it is executed or not can be designated by condition information for each outputting apparatus.

c. It is possible to designate that image data subjected to designated processing of each of 2)-8) are preserved as processed image data file. Re-processing of common processing section of output image for each output apparatus is removed.

d. For example, when an enlargement rate and a reduction rate of an output image for each output apparatus are different from others, if images which have been subjected to processing up to 6) are preserved, it is possible to shorten a period of time for 2)-6) by reading images which have been subjected to processing up to 6) and by processing and transferring only 7) and 8), when transmitting to another apparatus.

e. Processing 5) and 6) are conducted simultaneously with either one of 2), 3) and 4). Access of memory is reduced, and processing time can be shortened.

H. Utility Function

a. As a utility for a user, some functions are provided thereto. Utility function is restricted by a password for each of general user, a manager and a maker. In particular, for a change of information relating to images, a password of a manager is required for security.

b. Image File Operation

1) An image file list is displayed, and information concerning images preserved is displayed on image display device 22 in the order of receiving.

2) When a desired image is selected from the list, patient information, condition information and images are displayed in the same form as in the screen in the case of image confirmation.

3) Patient information, image processing methods and outputting methods can be changed.

4) With regard to the image designated to be “reservation” in the case of radiographing, the “reservation” can be canceled by reconfirming here.

5) The order of outputting can be changed, including whether outputting to each outer apparatus is conducted or not.

c. Radiographing Record, Emission Record

1) Radiographing information and patient information are processed statistically, and are provided to a user as a radiographing record and an emission record.

2) The number of shots per each radiographing region for a designated period and a list of radiographing conditions for shots per day can be outputted.

d. Customizing

A screen and operating procedures can be customized for each user.

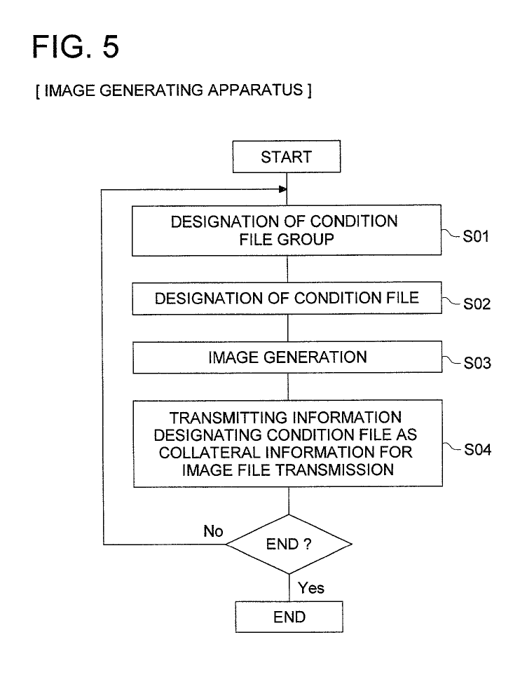

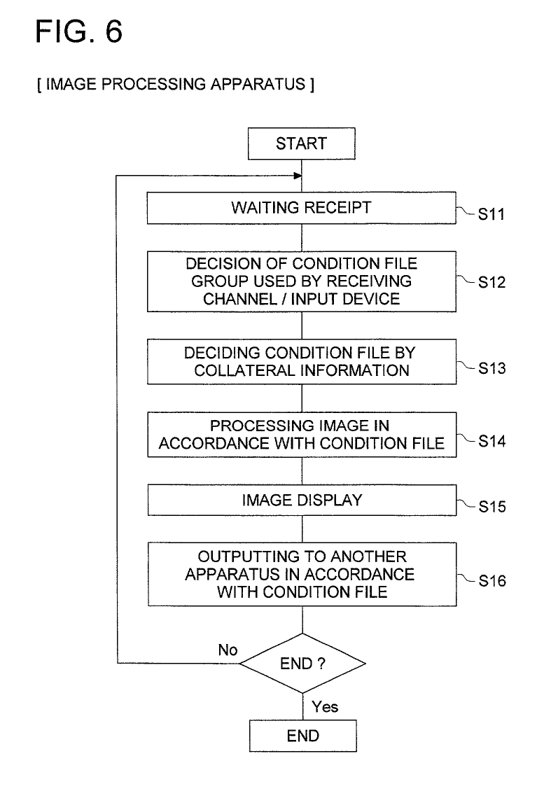

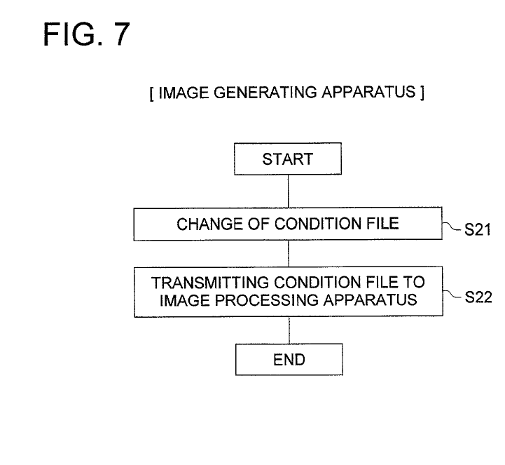

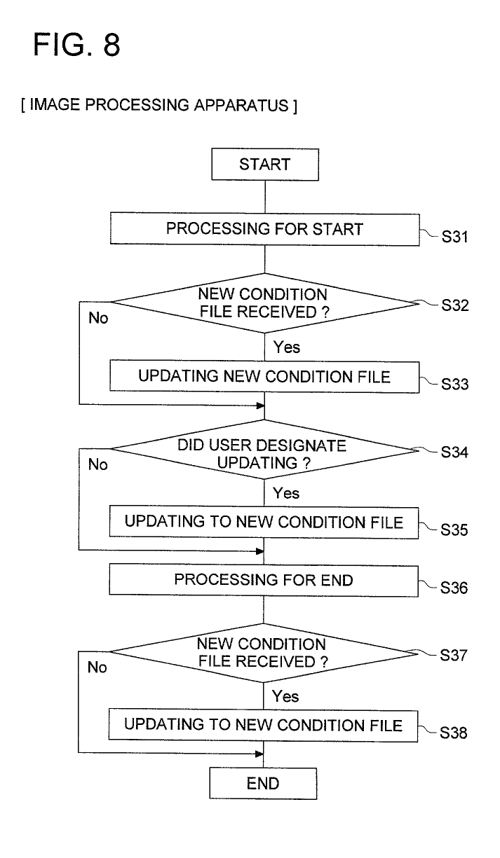

Next, selection and updating of the condition file in medical image generating apparatus 1 and medical image processing apparatus 2 shown in FIG. 1-FIG. 4 will be explained as follows, referring to FIG. 5-FIG. 8. FIG. 5 is a flow chart showing an example wherein the condition file is designated and is transmitted together with an image file by an image generating apparatus, FIG. 6 is a flow chart showing an example wherein an image processing apparatus conducts image processing and transmission under the condition of the condition file received from an image generating apparatus, FIG. 7 is a flow chart wherein the condition file has been updated on an image generating apparatus, and FIG. 8 is a flow chart showing an example of the flow up to the moment when the condition file has been updated on an image processing apparatus by the updating on the image generating apparatus shown in FIG. 7.

Condition files in quantity of 720 classified roughly and divided into groups as how to hold condition keys of plural patterns in medical image generating apparatus 1 and medical image processing apparatus 2 are controlled as the same condition file group. For example, they have patterns of plural condition file groups each being matched with a use.

### EXAMPLE 1

Pattern A: Standing type (corresponding to reader 11a)

Pattern B: Lying type (corresponding to reader 11b)

Pattern C: Cassette type (corresponding to reader 11)

### EXAMPLE 2

Pattern A: For ordinary radiographing room

Pattern B: For emergency radiographing room

### EXAMPLE 3

Pattern A: For radiographing room for the internal department

Pattern B: For radiographing room for orthopedics

Pattern C: For radiographing room for the head

These condition file groups are stored and preserved in preserving sections 31 and 41, and are preserved in both of medical image generating apparatus 1 and in medical image generating apparatus 2.

With respect to selection of a condition file, the aforesaid condition file is displayed on each of image display devices 13 and 22, and each pattern is provided with a selection button. As shown in FIG. 5, the pattern (condition file group) to be used in image generating apparatus 1 is designated and selected by a selection button (S01). This designation makes the condition file list of each pattern to be displayed on a screen of image display device 13. From this condition file list, the condition file is selected by designating one of them (S02). The foregoing makes it possible to select the optimum condition file for reader 11, reader 11a or reader 11b, and operations become easy. Incidentally, it is also possible to use a combo box for selection of each pattern.

The image generating apparatus 1 conducts reading of radiographic image information with the condition file designated as stated above, and generates images (S03). An image file including image data generated in the aforesaid manner is transmitted from image generating apparatus 1 to image processing apparatus 2 through the network 10, and in this case, information designating the condition file as collateral information is also transmitted (S04).

With respect to correspondence between each pattern in image processing apparatus 2 and receiving channel/inputting device (readers 11, 11a and 11b), a pattern is corresponded to each type of a channel to input image file or of an inputting device, as shown in the following example.

### EXAMPLE 1

Inputting channel 1→Pattern A

Inputting channel 2→Pattern A

Inputting channel 3→Pattern B

Inputting channel 4→Pattern C

### EXAMPLE 2

Inputting channel 1=CR standing type→Pattern A (corresponding to reader 11a)

Inputting channel 2=CR lying type→Pattern B (corresponding to reader 11b)

Inputting channel 3=CR cassette type→Pattern C (corresponding to reader 11)

Inputting channel 4=CR cassette type→Pattern C

Inputting channel 5=CT→Pattern D

As shown in FIG. 6, image processing apparatus 2 receives, in the state of waiting the receiving (S11), the image file transmitted from image generating apparatus 1 in step S04 in FIG. 1 and the collateral information, then, determines a condition file to be used by receiving channel/inputting device (S12), and determines the condition file in accordance with the collateral information (SS13). Incidentally, image processing apparatus 2 is provided with a table which corresponds the aforesaid each pattern to receiving (input) channel/inputting device, and this table is consulted when designating the condition file.

With respect to a means to designate a condition file from image generating apparatus 1 to image processing apparatus 2, the same condition file group is preserved in advance in a storage device such as a hard disc of each of the image generating apparatus 1 and the image processing apparatus 2. In this case, it is also possible to make the same condition file group to be held on a hard disc shared by another apparatus on the network 10. Then, the image generating apparatus 1 designates, concerning which condition file on which pattern is to be used, to the image processing apparatus 2. This designation is included in collateral information of image file including image data to be transmitted (see step S04 in FIG. 5). It is also possible to designate by transmitting as a command that is separate from the image file or as a file.

When the condition file is designated to image processing apparatus 2 from image generating apparatus 1, the image processing apparatus 2 changes the setting of default of the condition file relating to image processing to image data received from the image generating apparatus 1 to the condition file designated from the image generating apparatus 1. Further, when the condition file group (pattern) is designated to the image processing apparatus 2 from the image generating apparatus 1, the image processing apparatus 2 changes the setting of default of the condition file group relating to image processing to the image data received from the image generating apparatus 1, while, on default, an operator of the image processing apparatus 2 may select the condition file from condition file groups (pattern) which are set on a default basis. It is also possible to change the setting of default of the condition file groups (pattern) to the condition file group (pattern) corresponding to the receiving channel in the case of receiving image data or to the inputting device.

Next, on the image processing apparatus 2, image processing is conducted in accordance with the aforesaid condition file (S14), images are displayed on image display device 22 (S15), and the image file is outputted to another apparatus such as image server 5 in accordance with the condition file, through the network 10 (S16)>

Next, steps relating to updating (identification) after changing of the condition file in an image generating apparatus and an image processing apparatus will be explained as follows, referring respectively to FIG. 7 and FIG. 8.

When the condition file is changed by image generating apparatus 1 (S21), the image generating apparatus 1 transmits the changed condition file to image processing apparatus 2 as shown in FIG. 7 (S22). This transmission can be conducted by writing with FTP (file transfer protocol) or an original protocol on a common folder provided on the image generating apparatus 1, the image processing apparatus 2 or on another apparatus.

Next, as shown in FIG. 8, the image processing apparatus 2 is subjected to processing for starting (S31) to be booted up, and checks whether a new condition file has been received or not (S32), and if it has been received, it is updated to a new condition file (S33).

Next, under the condition of starting the image processing apparatus 2, confirmation is made whether updating of the condition file has been designated by a user or not (S34), and when it has been designated, it is updated to the new condition file (S35). Then, when processing to bring the image processing apparatus 2 to an end to be shut down is conducted (S36), a new condition file is checked whether it has been received or not (S37), and when it has been received, it is updated to the new condition file (S38).

Incidentally, when the condition file has been changed with the image processing apparatus 2, the condition file changed equally is transmitted to the image generating apparatus 1. This transmission can be conducted by writing with FTP (file transfer protocol) or an original protocol on a common folder provided on the image generating apparatus 1, the image processing apparatus 2 or on another apparatus. Then, the image generating apparatus 1 updates to the new condition file in the case of at least one occasion of apparatus boot up, apparatus shut down and designation by a user.

As in the foregoing, even when the condition file is changed with the image generating apparatus 1 or with the image processing apparatus 2, it is updated by the other apparatus, namely, by the image processing apparatus 2 or by the image generating apparatus 1, thereby, both apparatuses can own the same condition file.

The invention has been explained as stated above, referring to the embodiments to which, however, the invention is not limited, and various variations are possible within a range of technical concept of the invention. For example, a plurality of medical image generating apparatuses and/or a plurality of image processing apparatuses may be connected respectively to the medical network of the invention. Further, in FIG. 8, implementation of at least one of steps S32, S34 and S37 for updating the condition file is enough, and all of the steps are not necessarily needed. In FIG. 5 and FIG. 6, it is naturally possible to determine the condition file on the image processing apparatus side, and to designate the condition file to the image generating apparatus.

In the medical image generating apparatus, the medical image processing apparatus and the medical network system all of the invention, it is possible to select the optimum condition file easily, and to make operations to be easy.

What is claimed is:

1. A medical image generating apparatus, comprising:
a means for generating medical image data;
a means for transmitting said medical image data to another apparatus;
a preserving means for forming a condition file wherein information for processing said medical image data to output is preset, for administering a plurality of said condition file so as to be grouped as a condition file group, and for preserving a plurality of said condition file group;
a first designating means for designating said condition file group from said plurality of condition file group;
a second designating means for designating said condition file to be used from said condition file group, designated by said first designating means; and
a means for conducting image processing with said condition file, designated by said second designating means.

2. A medical image processing apparatus, comprising:
a means for receiving medical image data from another apparatus;
a preserving means for forming a condition file wherein information for processing said medical image data to output is preset, for administering a plurality of said condition file so as to be grouped as a condition file group, and for preserving a plurality of said condition file group;
a first designating means for designating said condition file group from said plurality of condition file group;
a second designating means for designating said condition file to be used from said condition file group, designated by said first designating means; and
a means for conducting image processing with said condition file, designated by said second designating means.

3. A medical image processing apparatus, comprising:
a means for receiving medical image data from another apparatus;
a preserving means for forming a condition file wherein information for processing said medical image data to output is preset, for administering a plurality of said condition file so as to be grouped as a condition file group, and for preserving a plurality of said condition file group;
a means for designating said condition file group in correspondence with each receiving channel;
a means for determining said condition file through a predetermined method from said condition file group, designated by said means for designating; and
a means for conducting image processing with said condition file, determined by said means for determining.

4. A medical image processing apparatus, comprising:
a means for receiving medical image data from another apparatus;
a preserving means for forming a condition file wherein information for processing said medical image data to output is preset, for administering a plurality of said condition file so as to be grouped as a condition file group, and for preserving a plurality of said condition file group;
a means for designating said condition file group in correspondence with each input device;
a means for determining said condition file through a predetermined method from said condition file group, designated by said means for designating; and
a means for conducting image processing with said condition file, determined by said means for determining.

5. A medical network system, comprising:
a medical image generating apparatus for generating medical image data, and for transmitting said medical image data to another apparatus;
a medical image processing apparatus for receiving said medical image data through a network;
a preserving means, for common use of said medical image generating apparatus and said medical image processing apparatus, for forming a condition file wherein information for processing said medical image data to output is preset, for administering a plurality of said condition file so as to be grouped as a condition file group, and for preserving a plurality of said condition file group;
wherein said medical image generating apparatus designates said condition file from said plurality of said condition file group; and
said condition file, designated by said medical image generating apparatus, becomes said condition file of default image processing, when said condition file is designated by said medical image generating apparatus for said medical image processing apparatus.

6. The medical network system of claim 5, wherein said medical image generating apparatus includes a designating means for designating said condition file by collateral information of said medical image data, transmitted to said image processing apparatus.

7. The medical network system of claim 5, wherein said medical image generating apparatus includes a designating means for designating said condition file by a command or a file, separated from said medical image data, transmitted to said image processing apparatus.

8. A medical network system, comprising:
a medical image generating apparatus for generating medical image data, and for transmitting said medical image data to another apparatus;
a medical image processing apparatus for receiving said medical image data through a network;
a preserving means, provided separately but preserving essentially the same contents to each of said medical image generating apparatus and said medical image processing apparatus, for forming a condition file wherein information for processing said medical image data to output is preset, for administering a plurality of said condition file so as to be grouped as a condition file group, and for preserving a plurality of said condition file group;
wherein said medical image generating apparatus designates said condition file from said plurality of said condition file group; and
said condition file, designated by said medical image generating apparatus, becomes said condition file of default image processing, when said condition file is designated by said medical image generating apparatus for said medical image processing apparatus.

9. The medical network system of claim 8, wherein said medical image generating apparatus includes a designating means for designating said condition file by collateral information of said medical image data, transmitted to said image processing apparatus.

10. The medical network system of claim 8, wherein said medical image generating apparatus includes a designating means for designating said condition file by a command or a file, separated from said medical image data, transmitted to said image processing apparatus.

11. A medical network system, comprising:
a medical image generating apparatus for generating medical image data, and for transmitting said medical image data to another apparatus; further comprising:
a) a changing means for a condition file wherein information for processing said medical data to output is preset; and
b) a transmitting means for said condition file, changed by said means for changing, to said medical image processing apparatus;
a medical image processing apparatus for receiving said medical image data through said network;
wherein said medical image processing apparatus conducts changes to said condition file received from said medical image generating apparatus, in case of at least one of boot up, shut down of said medical image processing apparatus and designation inputted by an operator.

12. The medical network system of claim 11, wherein said transmitting means is provided with a means for writing said condition file, changed by said changing means, on a common folder provided on at least one of said image generating apparatus, said image processing apparatus and other apparatuses.

13. A medical network system, comprising:
a medical image generating apparatus for generating medical image data, and for transmitting said medical image data to another apparatus;
a medical image processing apparatus for receiving said medical image data through said network; further comprising:
a) a changing means for a condition file wherein information for processing said medical data to output is preset; and
b) a transmitting means for said condition file, changed by said means for changing, to said medical image processing apparatus;
wherein said medical image generating apparatus conducts changes to said condition file received from said medical image processing apparatus, in case of at least one of boot up, shut down of said medical image generating apparatus and designation inputted by an operator.

14. The medical network system of claim 13, wherein said transmitting means is provided with a means for writing said condition file, changed by said changing means, on a common folder provided on at least one of said image generating apparatus, said image processing apparatus and other apparatuses.
